(19) United States
(12) Patent Application Publication
(10) Pub. No.: US 2026/0351601 A1
(43) Pub. Date: Nov. 5, 2026

(54) NEGATIVE ELECTRODE ACTIVE MATERIAL FOR SECONDARY BATTERY, AND SECONDARY BATTERY

(71) Applicant: Panasonic Intellectual Property Management Co., Ltd., Kadoma-shi, Osaka (JP)

(72) Inventor: Isao Koizumi, Osaka Fu (JP)

(73) Assignee: Panasonic Intellectual Property Management Co., Ltd., Kadoma-shi, Osaka (JP)

(21) Appl. No.: 19/486,182

(22) PCT Filed: May 21, 2024
(86) PCT No.: PCT/JP2024/018678

§ 371 Date: Nov. 20, 2025

(30) Foreign Application Priority Data
May 24, 2023 (JP) 2023-085588

(51) Int. Cl. H01M 4/58; H01M 4/02; H01M 4/38; H01M 4/62; H01M 10/0525

(52) U.S. Cl. CPC H01M 4/5825; H01M 4/386; H01M 4/624; H01M 10/0525; H01M 2004/027

(57) ABSTRACT

A negative electrode active material for secondary batteries includes silicon-containing particles, the silicon-containing particles each including an ion-conducting phase, and silicon phases dispersed in the ion-conducting phase. The silicon-containing particles contain lithium and an element A1. The concentration of the element A1 is higher in a surface portion than in an interior of the silicon-containing particle, and the element A1 is at least one selected from the group consisting of an alkali metal element other than lithium and a Group II element in the long-form periodic table.

### TECHNICAL FIELD

The present disclosure relates to a negative electrode active material for secondary batteries, and a secondary battery.

### BACKGROUND ART

In a negative electrode of secondary batteries represented by lithium-ion secondary batteries, in which a negative electrode active material capable of absorbing and releasing lithium ions is used, graphite has been typically used as such a negative electrode active material. In recent years, with respect to the negative electrode active material, studies have been made on a material containing silicon, which has a larger capacity density than graphite.

Patent Literature 1 proposes “a negative electrode active material for secondary batteries, comprising silicate composite particles, the silicate composite particles each including a silicate phase, and silicon particles dispersed in the silicate phase, wherein the silicate phase is an oxide phase containing Si, O, and an alkali metal, and the alkali metal containing at least K and Li″.

### CITATION LIST

### Patent Literature

Patent Literature 1: International Publication WO2020/045256

### SUMMARY OF INVENTION

### Technical Problem

In a secondary battery using a material containing silicon, achieving both excellent rate characteristics and cycle characteristics is required.

### Solution to Problem

In view of the above, one aspect of the present disclosure relates to a negative electrode active material for secondary batteries, including: silicon-containing particles, the silicon-containing particles each including an ion-conducting phase, and silicon phases dispersed in the ion-conducting phase, wherein the silicon-containing particles contain lithium and an element A1, a concentration of the element A1 is higher in a surface portion than in an interior of the silicon-containing particle, and the element A1 is at least one selected from the group consisting of an alkali metal element other than lithium and a Group II element in a long-form periodic table.

Another aspect of the present disclosure relates to a secondary battery, including: a positive electrode; a negative electrode; and an electrolyte, wherein the negative electrode includes the above-described negative electrode active material for secondary batteries.

### Advantageous Effects of Invention

According to the present disclosure, with respect to a secondary battery, it is possible to achieve both excellent rate characteristics and cycle characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic cross-sectional view of an example of a negative electrode active material (silicon-containing particle) according to one embodiment of the present disclosure.

FIG. 2 A partially cut-away schematic oblique view of a secondary battery according to one embodiment of the present disclosure.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” means to include the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

A negative electrode active material for secondary batteries according to one embodiment of the present disclosure includes silicon-containing particles. The silicon-containing particles each include an ion-conducting phase, and silicon phases dispersed in the ion-conducting phase. The silicon-containing particles contain lithium (Li), and an element A1. The concentration of the element A1 is higher in the surface portion than in the interior of the silicon-containing particle. The element A1 is at least one selected from the group consisting of an alkali metal element other than lithium and a Group II element in the long-form periodic table. Hereinafter, the silicon-containing particles may be referred to as “composite particles”. The silicon may be referred to as “silicon” or “Si”.

The composite particles may contain one kind or a plurality of kinds of elements A1. When the composite particles contain a plurality of kinds of elements A1, the total concentration of the plurality of kinds is higher in the surface portion than in the interior of the composite particle. In this case, the concentrations of the plurality of kinds may be individually higher in the surface portion than in the interior of the composite particle.

The ion-conducting phase may include, for example, at least one selected from the group consisting of a silicate phase and a silicon oxide phase. Hereinafter, at least one of the silicate phase and the silicon oxide phase may be referred to as a “silicon compound phase.” The silicon compound phase can form an amorphous phase. The composite particles in which silicon particles are dispersed in the silicate phase may be referred to as to as “silicate phase-containing composite particles”. The composite particles in which the silicate phase is a lithium silicate phase may be referred to as “lithium silicate phase-containing composite particles.” The composite particles in which silicon phases are dispersed in the silicon oxide phase may be referred to as “silicon oxide phase-containing composite particles”.

When the composite particles contain Li and an element A1, and the concentration of the element A1 is higher in the surface portion than in the interior of the composite particle, the reactivity of the composite particles is significantly improved, and the overvoltage is suppressed, which significantly improve the rate characteristics (rapid charge-discharge characteristics). By adding a small amount of the element A1 efficiently to the composite particle on its surface side, the reactivity of the composite particles can be significantly improved.

Although not yet clear, the detailed mechanism by which the reactivity of composite particles is improved is presumably as follows. When the element A1, which has a high ionization tendency, is present abundantly on the surface side of the composite particle, the desolvation of Li ions is facilitated at the surface of the composite particle. When the element A1, which has a larger ionic radius than Li, is present abundantly on the surface side of the composite particle, distortion occurs in the amorphous structure of the ion-conducting phase at the surface of the composite particle, leading to improved Li-ion diffusion rate within the composite particle. Presumably because of these factors, the reactivity of the composite particles (the reactivity between Li and the ion-conducting phase) is improved.

In other words, it can be said that, in the composite particles of the present disclosure, the concentration of the element A1 is smaller in the interior than in the surface portion. In a material containing silicon, when its reactivity is improved, particle cracking tends to occur during charging and discharging, and a new active surface formed by particle cracking comes in contact with the electrolyte, to facilitate side reactions therebetween, causing the cycle characteristics to degrade. In this respect, in the composite particles of the present disclosure, the reactivity is improved by increasing the concentration of the element A1 in the surface portion of the particle, while the particle cracking and the degradation of the cycle characteristics resulting therefrom can be suppressed by decreasing the concentration of the element A1 in the interior of the particle. In short, according to the present disclosure, it is possible to achieve both excellent rate characteristics and cycle characteristics.

### (Element A1 and Lithium)

The element A1 and lithium are contained in the ion-conducting phase. The element A1 and lithium being contained in the ion-conducting phase includes the situations where the element A1 and lithium are present at the interface between the ion-conducting phase and the silicon phases, and where they are present at the surface of the composite particles. The element A1 may be contained as a compound containing the element A1 (oxide, etc.), and may be contained in a solid solution state. The lithium may be contained as a compound containing lithium (lithium silicate, etc.), and may be contained in a solid solution state.

The alkali metal element other than lithium includes potassium (K), sodium (Na), and the like. The Group II element in the long-form periodic table include magnesium (Mg), calcium (Ca), and the like. The element A1 is preferably at least one selected from the group consisting of potassium, sodium, magnesium, and calcium.

In the composite particle, the concentration of the element A1 is higher in the surface portion than in the interior. Given that the concentration of the element A1 at a depth of 100 nm from the surface of the composite particle is X mass %, and the concentration of the element A1 in the whole composite particle is Y mass %, a ratio of X/Y may be 2 or more, or 3 or more, may be 5 or more, and may be 10 or more, or 15 or more. The concentration X is, for example, 0.1 to 20 mass %. The concentration Y is, for example, 0.05 to 5 mass %.

The concentration X is a proportion (mass ratio) of the element A1 in the total elements present at a depth of 100 nm from the surface of the composite particle. The concentration X (mass %) of the element A1 at a depth of 100 nm from the surface of the composite particle can be determined by X-ray photoelectron spectroscopy (XPS), energy dispersive X-ray spectroscopy using a scanning electron microscope (SEM-EDX), or other techniques.

The concentration Y is a proportion (mass ratio) of the element A1 in the whole composite particle. The concentration Y (mass %) of the element A1 in the whole composite particle can be determined by inductively coupled plasma optical emission spectroscopy (ICP), SEM-EDX analysis, or other techniques. Details of the ICP analysis and the SEM-EDX analysis on the composite particle will be described later.

The lithium may be uniformly distributed throughout the composite particle (in depth direction), or the concentration of the lithium may be higher in the surface portion than in the interior of the composite particle. At least one selected from the group consisting of Li₂CO₃, Li₂O, and LiOH may be attached to the surface of the composite particles. These compounds can be used as a Li-containing raw material in the production process of composite particles (in the second step described later), and can remain as an unreacted material at the surface of the particles. In the lithium contained in the composite particles, the lithium remaining as an unreacted material can also be included.

### (Element A2)

The composite particles may contain an element A2 (an element other than lithium, element A1, silicon, and oxygen). In this case, the element A2 is contained in the ion-conducting phase. The element A2 being contained in the ion-conducting phase includes the situations where the element A2 is present at the interface between the ion-conducting phase and the silicon phases, and where it is present at the surface of the composite particles. The element A2 may be contained as a compound containing the element A2 (oxide, etc.), and may be contained in a solid solution state.

From the viewpoints of improving electrical conductivity and suppressing particle cracking (e.g., improving Vickers hardness), the element A2 is preferably at least one selected from the group consisting of aluminum (Al), boron (B), bismuth (Bi), antimony (Sb), germanium (Ge), zirconium (Zr), titanium (Ti), phosphorus (P), vanadium (V), tungsten (W), and lanthanum (La). In this case, the rate characteristics and the cycle characteristics are likely to be improved. The content of the element A2 in the composite particles (the total content of Al and B) may be 0.01 mass % or more, relative to the total mass of the composite particles. The composite particles may contain one kind of element A2 or a plurality of kinds of elements A2. With regard to the concentration distribution of the element A2 in the depth direction of the composite particle, there is no particular limitation.

### (Composite Particles)

The composite particles have a structure in which silicon phases are dispersed in an ion-conducting phase (matrix). The ion-conducting phase alleviates the stress associated with expansion and contraction of the silicon phases during charging and discharging, to suppress the cracking and fracture of the composite particles. It is therefore possible to achieve both high capacity, which is resulted from silicon inclusion, and improved cycle characteristics. The ion-conducting phase may be constituted of a single phase, and may be constituted of a plurality of phases.

The silicon oxide phase is constituted of a compound of Si and O. The major component (e.g., 95 to 100 mass %) of the silicon oxide phase may be silicon dioxide. The composite particles may be silicon oxide phase-containing composite particles. The silicon oxide phase-containing composite particles are expressed by, for example, a formula SiOₓ where 0.5≤x<1.6.

The silicate phase is constituted of a compound containing a metal element, silicon (Si), and oxygen (O). Examples of the metal element include an alkali metal element, such as lithium, and a Group II element in the long-form periodic table. The silicate phase preferably contains at least lithium silicate. In this case, lithium ions can easily enter and exit the silicate phase. The lithium silicate phase has a smaller irreversible capacity than the silicon oxide phase. The composite particles may be silicate phase-containing composite particles. The ion-conducting phase may contain, for example, the silicate phase as a major component, and a small amount of the silicon oxide phase. Here, the “major component” refers to a component that accounts for 50 mass % or more of the total mass of the silicon compound phase, and may account for 70 mass % or more thereof. The silicate phase (lithium silicate phase) can contain at least one selected from the group consisting of Li₂Si₂O₅, Li₂SiO₃, and Li₄SiO₄.

An atomic ratio O/Si of O to Si in lithium silicate is, for example, more than 2 and less than 4. When the O/Si ratio is more than 2 and less than 4 (z in the formula below is 0<z<2), this is advantageous in terms of the stability of the silicate phase and the lithium ion conductivity. The ratio O/Si is preferably more than 2 and less than 3. An atomic ratio Li/Si of Li to Si in the lithium silicate is, for example, more than 0 and less than 4.

The composition of the lithium silicate can be expressed by a formula: Li_{2z}SiO_{2+z} where 0<z<2. From the viewpoints of the stability, the ease of production, the lithium ion conductivity, and the like, z preferably satisfies the relationship 0<z≤1, and more preferably z=1/2. When z=1, the lithium silicate can be expressed as Li₂SiO₃, and when z=1/2, expressed as Li₂Si₂O₅.

The average particle diameter of the fine silicon phases (before charging for the first time) dispersed in the ion-conducting phase may be 500 nm or less, may be 200 nm or more, and may be 50 nm or less. By micronizing the silicon phases moderately as above, the changes in volume during charging and discharging are reduced, leading to improved structural stability. In addition, the expansion and contraction of the silicon phases become uniform, and the particle cracking is suppressed, leading to improved cycle characteristics. The average particle diameter of the silicon phases is measured by observing a cross section of the composite particle using a SEM or TEM. Specifically, it is determined by averaging the maximum diameters of randomly selected 100 silicon phases.

The silicon phases dispersed in the ion-conducting phase are each a particulate phase of simple silicon (Si) and constituted of a single crystallite or a plurality of crystallites. From the viewpoint of reducing the amount of changes in volume due to expansion and contraction of the silicon phases (silicon particles) during charging and discharging, and making it easy to improve the cycle characteristics, the crystallite size of the silicon phases may be 50 nm or less, preferably 20 nm or less, more preferably 10 nm or less. The lower limit of the crystallite size of the silicon phases is, for example, 5 nm or more. The crystallite size of the silicon phases is calculated using the Scherrer's equation from the half-value width of the diffraction peak attributed to the Si (111) plane in the X-ray diffraction (XRD) pattern.

From the viewpoints of achieving high capacity and improving the cycle characteristics, the content of the silicon phases in the composite particles may be 30 mass % or more (or 57 mass % or more) and 90 mass % or less, and may be 35 mass % or more and 75 mass % or less, relative to the total mass of the composite particles.

The average particle diameter of the composite particles is, for example, 1 μm or more and 25 μm or less, and may be 4 pun or more and 15 μm or less. Within the above range, favorable battery performance is likely to be obtained. The average particle diameter of the composite particles is a particle diameter (volume average particle diameter) at 50% cumulative volume in a particle size distribution measured by a laser diffraction and scattering method. As the measuring instrument, for example, “LA-750”, available from Horiba, Ltd. (HORIBA) can be used.

### (Conductive Layer)

From the viewpoint of improving the conductivity, a conductive layer may be formed on the surface of the composite particles. The conductive layer contains, for example, a conductive carbon material. The thickness of the conductive layer is preferably thin enough not to substantially influence the average particle diameter of the composite particles. From the viewpoint of ensuring electrical conductivity, the thickness of the conductive layer is preferably 1 nm or more.

The conductive layer is formed by mixing a raw material of the conductive carbon material with the composite particles, and firing the mixture, to carbonize the raw material of the conductive carbon material. As the raw material of the conductive material, for example, coal pitch or coal tar pitch, petroleum pitch, phenolic resin, and the like can be used. The firing of the mixture of the raw material of the conductive carbon material and the composite particles is performed, for example, in an inert atmosphere (e.g., atmosphere of argon, nitrogen, etc.). The firing temperature is, for example, 450 °C or higher and 1000 °C or lower. Within the above temperature range, a conductive layer having high electrical conductivity can be easily formed on the silicate phase having low crystallinity. The firing temperature is preferably 550 °C or higher and 900 °C or lower, more preferably 650 °C or higher and 850 °C or lower. The firing time is, for example, 1 hour or more and 10 hours or less. The formation of a conductive layer onto the surface of the composite particles may be performed after the second step described later (the addition of an element A1, etc.).

### (Production of Silicon-Containing Particles)

The production process of silicon-containing particles includes, for example, a first step and a second step. In the first step, composite particles are prepared. When the composite particles (ion-conducting phase) prepared in the first step contain lithium, in the second step, an element A1 (or an element A1 and lithium) is added abundantly on the surface portion side of the composite particles. When the composite particles (ion-conducting phase) prepared in the first step contains no lithium, in the second step, lithium and an element A1 are added abundantly on the surface portion side of the composite particles.

### (First Step)

In the first step, composite particles each including an ion-conducting phase, and silicon phases dispersed in the ion-conducting phase are prepared. The ion-conducting phase includes at least one silicon compound phase selected from the group consisting of a silicate phase and a silicon oxide phase.

The composite particles (ion-conducting phase) prepared in the first step may not contain an element A1, or may contain an element A1. The composite particles (ion-conducting phase) prepared in the first step may contain an element A2.

### (Preparation of Silicon Oxide Phase-Containing Composite Particles)

As the silicon oxide phase-containing composite particles, for example, composite particles represented by a formula SiOₓ where 0.5≤x<1.6 may be prepared. The SiOₓ particles can be prepared by, for example, mixing SiO₂ and Si particles together, and heating the mixture under vacuum conditions, to obtain a vapor, which is then solidified. At this time, to the SiO₂ and Si particles serving as sublimation sources, an element A2 or a compound containing an element A2 may be added, so that the element A2 is contained in the SiOₓ particles (silicon oxide phase). According to the above production method, composite particles containing a silicon phase having a small crystallite size of, for example, 20 nm or less can be obtained.

### (Preparation of Silicate Phase-Containing Composite Particles)

As the silicate phase-containing composite particles, for example, composite particles containing a lithium silicate phase represented by Li_{2z}SiO_{2+z} where 0<z<2 may be prepared.

The silicate phase-containing composite particles can be obtained by, for example, pulverizing a mixture of a silicate (lithium silicate) and a raw material silicon under stirring in a ball mill or the like, to be micronized, then, subjecting the mixture to a heat treatment in an inert atmosphere, and pulverizing the sintered product obtained by the heat treatment. An element A2 may be contained in the silicate used as the raw material for the composite particles. A detailed description of the manufacturing method of lithium silicate phase-containing composite particles will be given later.

### (Second Step)

When the composite particles (ion-conducting phase) prepared in the first step contain lithium, in the second step, for example, a raw material containing an element A1 is heated, to obtain a molten material containing the element A1, and then, feeding the composite particles into the molten material for a predetermined time. In this way, the molten material and the composite particles are brought into contact with each other for a predetermined time. Thus, the element A1 can be distributed abundantly on the surface portion side of the composite particles.

When the composite particles (ion-conducting phase) prepared in the first step contain no lithium, in the second step, for example, a mixture of a raw material containing lithium and a raw material containing an element A1 is heated, to obtain a molten material containing lithium and the element A1, and then, feeding the composite particles into the molten material. Thus, the lithium and the element A1 can be distributed abundantly on the surface portion side of the composite particles.

Examples of the raw material containing an element A1 include carbonates, hydroxides, and oxides. In the case of containing no element A2 in the composite particles prepared in the first step, a raw material containing an element A2 may be contained in the molten material.

The above X/Y ratio (the concentration gradient of the element A1 in the depth direction of the composite particle) can be adjusted by, for example, the size (particle diameter) of the composite particles prepared in the first step, the feeding time of the composite particles into the molten material in the second step, the temperature of the molten material in the second step (the heating temperature of the raw material containing an element A1), and the like.

The adding amount of the element A1 may be, for example, 0.1 to 10 parts by mass, relative to 100 parts by mass of the composite particles. The adding amount of the lithium may be, for example, 0.1 to 10 parts by mass, relative to 100 parts by mass of the composite particles. The adding amount of the element A1 (or the Li and the element A1) to the composite particles can be adjusted by, for example, the feeding amount of the composite particles into the molten material.

The composite particles may be subjected to a heat treatment after the second step. The silicon phases in the composite particles may be crystal-grown by the heat treatment, to increase their crystallite size. The initial charge-discharge efficiency may be improved by moderately increasing the crystallite size of the silicon phases.

An example of the manufacturing method of lithium silicate phase-containing composite particles to be prepared in the first step will be described below in detail.

### Step (i) (Step of Obtaining Lithium Silicate)

As the raw material for lithium silicate, a raw material mixture containing a Si-containing raw material and a Li raw material in a predetermined ratio is used. In the raw material mixture, another element M may be contained, as necessary. Examples of the element M include the element A2. A lithium silicate is synthesized by melting a mixture of the above raw materials mixed in predetermined amounts, and passing the melt between metal rolls, into flakes. Then, the flakes of the lithium silicate are crystalized by a heat treatment in an atmospheric air at a temperature equal to or higher than the glass transition point, and equal to or lower than the melting point. Note that the flakes of the lithium silicate may be used without being crystalized. A silicate can also be produced, without melting the mixture of raw materials mixed in predetermined amounts, by firing the mixture at a temperature equal to or lower than the melting point, to cause a solid phase reaction.

For the Si raw material, silicon or silicon monoxide can be used. For the Li raw material, for example, lithium carbonate, lithium oxide, lithium hydroxide, lithium hydride, and the like can be used. For the raw material containing an element M, for example, an oxide, a hydroxide, a carbonate, a hydride, a nitrate, a sulfate, or the like of each element can be used. In the lithium silicate, the Si raw material having not reacted with the Li raw material can remain. The remaining Si raw material is dispersed in the form of fine crystals of silicon oxide, in the lithium silicate.

### Step (ii) (Step of Obtaining Silicate Composite Particles)

Next, the lithium silicate is blended with a raw material silicon, to be formed into a composite. For example, through the following steps (a) to (c), composite particles are prepared.

### Step (a)

First, powder of a raw material silicon and powder of the lithium silicate are mixed in a mass ratio of, for example, 20:80 to 95:5. The raw material silicon may be coarse silicon particles having an average particle diameter of about several μm to several tens of μm.

### Step (b)

Next, using a pulverizer like a ball mill, the mixture of the raw material silicon and the lithium silicate is pulverized while being micronized, to be formed into a composite. At this time, an organic solvent may be added to the mixture, to perform wet pulverization. A predetermined amount of an organic solvent may be fed all at once into a pulverizing container at the early stage of pulverization, or may be fed dividedly in a plurality of times into a pulverizing container in the process of pulverization. The organic solvent serves to prevent an object to be pulverized from attaching to the inner wall of the pulverizing container.

As the organic solvent, an alcohol, an ether, a fatty acid, an alkane, a cycloalkane, a silicate ester, a metal alkoxide, and the like can be used.

As the raw material silicon, coarse silicon particles with an average particle diameter of about several μm to several tens of μm may be used. The finally obtained silicon particles (silicon phases) are preferably controlled such that a crystallite size calculated from the Scherrer's equation using the half-value width of a diffraction peak attributed to the Si(111) plane in the X-ray diffraction pattern is 5 nm or more and 50 nm or less.

The raw material silicon and the lithium silicate may be micronized separately, and mixed together. Alternatively, without using a pulverizer, silicon nanoparticles and amorphous lithium silicate nanoparticles may be prepared, which may be mixed together. For the production of nanoparticles, a known method, such as a gas phase method (e.g., plasma method) and a liquid phase method (e.g., liquid phase reduction method), may be used.

### Step (c)

Next, the pulverized material is fired under application of a pressure thereto with a hot press or the like, to obtain a sintered body. The firing is performed, for example, in an inert atmosphere (e.g., an atmosphere of argon, nitrogen, etc.). The firing temperature is preferably 450 °C or higher and 1000 °C or lower Within the above temperature range, fine silicon phases can be easily dispersed in the silicate phase having low crystallinity. During sintering, the lithium silicate softens and flows so as to fill the gaps between the silicon particles. As a result, a dense block-shaped sintered body including the silicate phase as a sea portion, and the silicon particles (silicon phases) as island portions can be obtained. The firing temperature is preferably 550 °C or higher and 900 °C or lower, more preferably 650 °C or higher and 850 °C or lower. The firing time is, for example, 1 hour or more and 10 hours or less.

Pulverizing the resultant sintered body can provide composite particles. Composite particles having a predetermined average particle diameter can be obtained by selecting the pulverization conditions as appropriate.

Through the steps (i) and (ii), composite particles each including the silicate phase as a matrix, and the silicon phases dispersed in the matrix can be obtained.

The composition of the composite particles can be determined, for example, by the following analysis method.

### <EDX>

From a cross-sectional backscattered SEM electron image of the negative electrode mixture layer, 10 composite particles having a maximum particle diameter of 5 μm or more are randomly selected, to perform an elemental mapping analysis by energy dispersive X-ray (EDX) on each particle. The area percentage of the target element is calculated using an image analysis software. The observation magnification is desirably 2,000 to 20,000 times. The measured values of the area percentage of a predetermined element contained in the 10 particles are averaged. From the obtained average value, the contained amount of the target element can be calculated.

Desirable cross-sectional SEM-EDX analysis measurement conditions are shown below.

### <SEM-EDX Measurement Conditions>

Processing apparatus: SM-09010 (Cross Section Polisher), available from JEOL

Processing conditions: accelerating voltage 6 kV

Current value: 140 HA

Degree of vacuum: 1×10⁻³ to 2×10⁻³ Pa

Measuring apparatus: Electron microscope SU-70 available from HITACHI

Acceleration voltage during analysis: 10 kV

Field: Free mode

Probe current mode: Medium

Probe current range: High

Anode Ap.: 3

OBJ Ap.: 2

Analysis area: 1 μm square

Analysis software: EDAX Genesis

CPS: 20,500

Lsec: 50

Time constant: 3.2

### <ICP>

A sample of the composite particles is completely dissolved in a heated acid solution (a mixed acid of hydrofluoric acid, nitric acid, and sulfuric acid), and carbon of the residue of dissolution is removed by filtration. Then, the obtained filtrate is analyzed by inductively coupled plasma emission spectroscopy (ICP), to measure a spectral intensity of each element. Subsequently, using a commercially available standard solution of the element, a calibration curve is drawn, from which the content of each element in the composite particles is calculated.

The amounts of the element A1 and the element A2 contained in the composite particles can be quantitatively analyzed in accordance with JIS R3105 (1995) (method for chemical analysis of borosilicate glass).

In the silicate phase-containing composite particles, a silicate phase and silicon phases are present, which can be distinguished from each other and quantitatively determined by using Si-NMR. The Si content obtained by the above method is the sum of the amount of Si constituting the silicon phases and the amount of Si in the silicate phase. The amount of Si elements contained in the composite particles is assigned into the silicate phase and the silicon phases, using the results of quantitative analysis by Si-NMR. Note that, as the standard substance necessary for quantitative determination, a mixture containing a silicate phase and silicon phases, in each of which the Si content is already known, in a predetermined ratio may be used.

Desirable Si-NMR measurement conditions are shown below.

### <Si-NMR Measurement Conditions>

Measuring apparatus: Solid nuclear magnetic resonance spectrometer (INOVA-400), available from Varian, Inc.

Probe: Varian 7 mm CPMAS-2

MAS: 4.2 KHz

MAS speed: 4 kHz

Pulse: DD (45° pulse+signal capture time 1H decoupling)

Repetition time: 1200 sec to 3000 sec

Observation width: 100 kHz

Observation center: around −100 ppm

Signal capture time: 0.05 sec

Accumulated number of times: 560

Sample amount: 207.6 mg

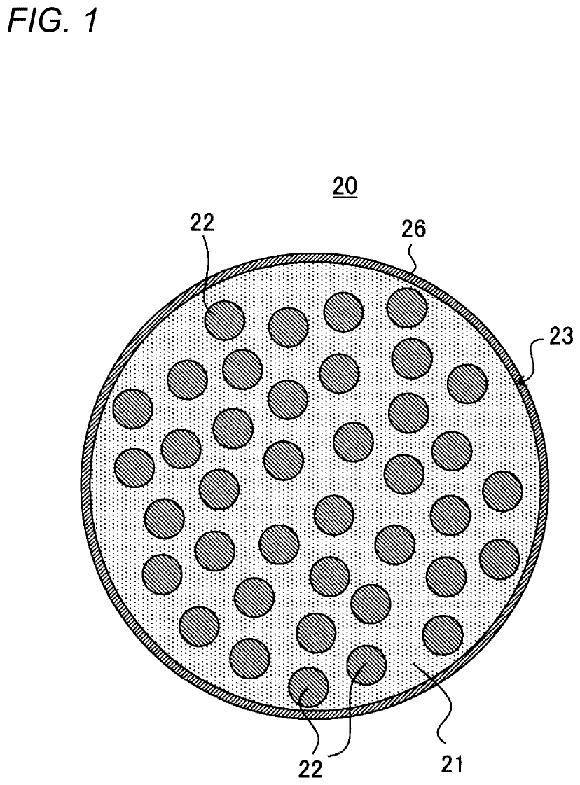

FIG. 1 is a schematic cross-sectional view of an example of the negative electrode active material (composite particle).

A negative electrode active material 20 includes a composite particle 23 (base particle). The composite particle 23 includes an ion-conducting phase 21 and silicon phases (silicon particles) 22 dispersed in the ion-conducting phase 21. The composite particle 23 has a sea-island structure in which the fine silicon phases 22 are dispersed in a matrix of the ion-conducting phase 21. The surface of the composite particle 23 is covered with a conductive layer 26. The composite particle 23 (ion-conducting phase 21) contains an element A1 and lithium. The concentration of the element A1 is higher on the surface portion side (the side closer to the conductive layer 26) than on the interior side of the composite particle 23.

### [Secondary Battery]

A secondary battery according to an embodiment of the present disclosure includes a positive electrode, a negative electrode, and an electrolyte. The negative electrode includes the above-described negative electrode active material for secondary batteries. Description will be given below of the negative electrode and other components of the secondary battery.

### [Negative Electrode]

The negative electrode includes, for example, a negative electrode mixture layer containing the above-described negative electrode active material for secondary batteries, and a negative electrode current collector supporting the negative electrode mixture layer. The negative electrode mixture layer can be formed by applying a negative electrode slurry of a negative electrode mixture dispersed in a dispersion medium, onto a surface of the negative electrode current collector, followed by drying. The applied film after drying may be rolled, as necessary. The negative electrode mixture layer may be formed on one surface or both surfaces of the negative electrode current collector.

The negative electrode mixture contains the above-described negative electrode active material for secondary batteries as an essential component, and may contain a binder, a conductive agent, a thickener, and the like, as optional components. The silicon phases in the composite particles can absorb a lot of lithium ions, and thus can contribute to achieving high capacity of the negative electrode. The contained amount of the composite particles in the negative electrode mixture layer may be 1 mass % or more and 50 mass % or less, relative to the total mass of the negative electrode mixture layer.

The negative electrode active material may further contain another active material that electrochemically absorbs and releases lithium ions. Preferred as another active material is, for example, a carbon-based active material. The composite particles expand and contract in volume in association with charging and discharging. Therefore, increasing their proportion in the negative electrode active material tends to cause a contact failure between the negative electrode active material and the negative electrode current collector. On the other hand, using the composite particles in combination with a carbon-based active material makes it possible to achieve excellent cycle characteristics, while imparting high capacity of the silicon particles to the negative electrode. The proportion of the composite particles in the total of the composite particles and the carbon-based active material is preferably, for example, 0.5 to 15 mass %, more preferably 1 to 5 mass %. In this case, high capacity and improved cycle characteristics are both likely to be achieved.

Examples of the carbon-based active material include graphite, graphitizable carbon (soft carbon), and non-graphitizable carbon (hard carbon). In particular, graphite is preferred because of its excellent charge-discharge stability and small irreversible capacity. Graphite means a material having a graphite-like crystal structure, and includes, for example, natural graphite, artificial graphite, graphitized mesophase carbon particles, and the like. The carbon-based active material may be used singly or in combination of two or more kinds.

As the negative electrode current collector, a non-porous conductive substrate (metal foil, etc.), and a porous conductive substrate (mesh, net, punched sheet, etc.) are used. Examples of the material of the negative electrode current collector include stainless steel, nickel, nickel alloy, copper, and copper alloy. The thickness of the negative electrode current collector is, although not limited to, preferably 1 to 50 μm, more preferably 5 to 20 μm, in view of the balance between high strength and lightweight of the negative electrode.

Examples of the binder include fluorocarbon resins, polyolefin resins, polyamide resins, polyimide resins, vinyl resins, styrene-butadiene copolymer rubber (SBR), polyacrylic acids, and derivatives thereof. These may be used singly or in combination of two or more kinds. Examples of the conductive agent include carbon black, conductive fibers, fluorinated carbon, and organic conductive materials. These may be used singly or in combination of two or more kinds. Examples of the thickener include carboxymethyl cellulose (CMC), and polyvinyl alcohol. These may be used singly or in combination of two or more kinds.

Examples of the dispersion medium include water, alcohols, ethers, N-methyl-2-pyrrolidone (NMP), and mixed solvents thereof.

### [Positive Electrode]

The positive electrode includes, for example, a positive electrode current collector, and a positive electrode mixture layer supported on a surface of the positive electrode current collector. The positive electrode mixture layer can be formed by applying a positive electrode slurry of a positive electrode mixture dispersed in a dispersion medium, onto a surface of the positive electrode current collector, followed by drying. The applied film after drying may be rolled, as necessary. The positive electrode mixture layer may be formed on one surface or both surfaces of the positive electrode current collector.

The positive electrode mixture contains a positive electrode active material as an essential component, and can contain a binder, a conductive agent, and the like, as optional components.

As the positive electrode active material, for example, a lithium-transition metal composite oxide can be used. Examples of the lithium-transition metal composite oxide include LiₐCoO₂, LiₐNiO₂, LiₐMnO₂, LiₐCo_{b}Ni_{1-b}O₂, LiₐCo_{b}M_{1+b}O_{c}, LiₐNi_{1-b}M_{b}O_{c}, LiₐMn₂O₄, LiₐMn_{2-b}M_{b}O₄, LiMePO₄, and Li₂MePO₄F. Here, M is at least one selected from the group consisting of Na, Mg, Sc, Y, Mn, Fe, Co, Ni, Cu, Zn, Al, Cr, Pb, Sb, and B. Me contains at least a transition element (e.g., contains at least one selected from the group consisting of Mn, Fe, Co, and Ni). Here, 0≤a≤1.2, 0≤b≤0.9, and 2.0≤c≤2.3. The value “a” representing the molar ratio of lithium increases and decreases during charging and discharging.

The binder and the conductive agent may be like those exemplified for the negative electrode. As the conductive agent, graphite, such as natural graphite and artificial graphite, may be used.

The shape and the thickness of the positive electrode current collector can be respectively selected from the shapes and the ranges corresponding to those of the negative electrode current collector. Examples of the material of the positive electrode current collector include stainless steel, aluminum, aluminum alloy, and titanium.

### [Electrolyte]

The electrolyte may be a liquid electrolyte (electrolyte solution), may be a gel electrolyte, and may be a solid electrolyte. The liquid electrolyte is, for example, an electrolyte solution containing a nonaqueous solvent and a salt dissolved in the nonaqueous solvent. The concentration of the salt in the electrolyte solution is, for example, 0.5 mol/L or more and 2 mol/L or less. The electrolyte solution may contain a known additive.

The gel electrolyte contains a salt and a matrix polymer, or contains a salt, a nonaqueous solvent, and a matrix polymer. As the matrix polymer, for example, a polymer material that absorbs a nonaqueous solvent and turns into a gel is used. Examples of the polymer material include fluorocarbon resins, acrylic resins, polyether resins, and polyethylene oxide.

As the solid electrolyte, for example, a known material for use in all-solid lithium-ion secondary batteries and the like (e.g., oxide-based solid electrolyte, sulfide-based solid electrolyte, halide-based solid electrolyte) is used.

For example, a nonaqueous electrolyte in a liquid state is prepared by dissolving a salt in a nonaqueous solvent. The salt is an electrolyte salt that ionically dissociates in the electrolyte, and can include, for example, a lithium salt. The electrolyte can contain various additives. The electrolyte is usually used as it is in a liquid state, but may be in a state in which the fluidity is restricted by a gelling agent or the like.

As the nonaqueous solvent, for example, a cyclic carbonic acid ester, a chain carbonic acid ester, a cyclic carboxylic acid ester, a chain carboxylic acid ester, and the like are used. Examples of the cyclic carbonic acid ester include propylene carbonate (PC), ethylene carbonate (EC), and vinylene carbonate (VC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL), and γ-valerolactone (GVL). Examples of the chain carboxylic acid ester include methyl acetate, ethyl acetate, propyl acetate, methyl propionate (MP), and ethyl propionate (EP). The nonaqueous solvent may be used singly or in combination of two or more kinds.

Other examples of the nonaqueous solvent include cyclic ethers, chain ethers, nitriles such as acetonitrile, and amides such as dimethylformamide.

As the lithium salt, for example, lithium salts of chlorine-containing acids (LiClO₄, LiAlCl₄, LiB₁₀Cl₁₀, etc.), lithium salts of fluorine-containing acids (LiPF₆, LiBF₄, LiSbF₆, LiAsF₆, LiCF₃SO₃, LiCF₃CO₂, etc.), lithium salts of fluorine-containing acid imides (LiN(CF₃SO₂)₂, LiN(CF₃SO₂)(C₄F₉SO₂), LiN(C₂F₅SO₂)₂, etc.), lithium halides (LiCl, LiBr, LiI, etc.), and the like can be used. These lithium salts may be used singly or in combination of two or more kinds.

The concentration of the lithium salt in the electrolyte may be 1 mol/liter or more and 2 mol/liter or less, and may be 1 mol/liter or more and 1.5 mol/liter or less. By controlling the lithium salt concentration in the above range, an electrolyte having excellent ion conductivity and moderate viscosity can be obtained. The lithium salt concentration is not limited to the above.

### [Separator]

Usually, it is desirable to interpose a separator between the positive electrode and the negative electrode. The separator is excellent in ion permeability and has moderate mechanical strength and electrically insulating properties. As the separator, for example, a microporous thin film, a woven fabric, a nonwoven fabric, and the like can be used. As the material of the separator, polyolefin, such as polypropylene and polyethylene, can be used.

One example of the structure of the secondary battery is a structure in which an electrode group formed by winding the positive electrode and the negative electrode with the separator interposed therebetween is housed in an outer body, together with the nonaqueous electrolyte. Alternatively, instead of the wound electrode group, another form of an electrode group may be adopted, such as a stacked electrode group formed by stacking the positive electrode and the negative electrode with the separator interposed therebetween. The secondary battery may be in any form, such as cylindrical type, prismatic type, coin type, button type, and laminate type.

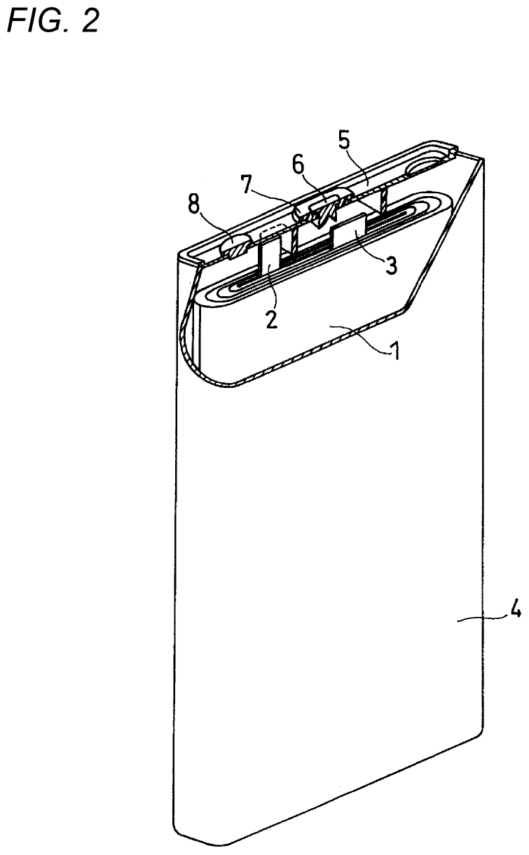

The structure of a prismatic nonaqueous electrolyte secondary battery as an example of a secondary battery according to the present disclosure will be described below with reference to FIG. 2. FIG. 2 is a partially cut-away schematic oblique view of a secondary battery according to one embodiment of the present disclosure.

The battery includes a bottomed prismatic battery case 4, and an electrode group 1 and a nonaqueous electrolyte (not shown) which are housed in the battery case 4. The electrode group 1 has a long belt-shaped negative electrode, a long belt-shaped positive electrode, and a separator interposed between the positive electrode and the negative electrode and preventing them from directly contacting with each other. The electrode group 1 is formed by winding the negative electrode, the positive electrode, and the separator together, around a flat plate-like winding core, and then removing the winding core.

To the negative electrode current collector, one end of a negative electrode lead 3 is attached, by means of welding or the like. The other end of the negative electrode lead 3 is electrically connected, via an insulating plate made of resin (not shown), to a negative electrode terminal 6 disposed at a sealing plate 5. The negative electrode terminal 6 is electrically insulated from the sealing plate 5 by a resin gasket 7. To the positive electrode current collector, one end of a positive electrode lead 2 is attached, by means of welding or the like. The other end of the positive electrode lead 2 is connected, via the insulating plate, to the back side of the sealing plate 5. That is, the positive electrode lead 2 is electrically connected to the battery case 4 serving as a positive electrode terminal. The insulating plate provides insulation between the electrode group 1 and the sealing plate 5 and between the negative electrode lead 3 and the battery case 4. The periphery of the sealing plate 5 is fitted to the opening end of the battery case 4, and the fitted portion is laser-welded. In this way, the opening of the battery case 4 is sealed with the sealing plate 5. A nonaqueous electrolyte injection port provided in the sealing plate 5 is closed with a sealing plug 8.

### (Supplementary Notes)

The above description of embodiments discloses the following techniques.

### (Technique 1)

A negative electrode active material for secondary batteries, comprising:
silicon-containing particles, the silicon-containing particles each including an ion-conducting phase, and silicon phases dispersed in the ion-conducting phase, wherein
the silicon-containing particles contain lithium and an element A1,
a concentration of the element A1 is higher in a surface portion than in an interior of the silicon-containing particle, and
the element A1 is at least one selected from the group consisting of an alkali metal element other than lithium and a Group II element in a long-form periodic table.

### (Technique 2)

The negative electrode active material for secondary batteries according to technique 1, wherein the element A1 is at least one selected from the group consisting of sodium, potassium, magnesium, and calcium.

### (Technique 3)

The negative electrode active material for secondary batteries according to technique 1 or 2, wherein,
given that a concentration of the element A1 at a depth of 100 nm from a surface of the silicon-containing particle is X mass %, and
a concentration of the element A1 in the whole silicon-containing particle is Y mass %,
a ratio of X/Y is 2 or more.

### (Technique 4)

The negative electrode active material for secondary batteries according to any one of techniques 1 to 3, wherein the ion-conducting phase includes at least one selected from the group consisting of a silicate phase and a silicon oxide phase.

### (Technique 5)

The negative electrode active material for secondary batteries according to technique 4, wherein the silicate phase includes at least one selected from the group consisting of Li₂Si₂O₅, Li₂SiO₃, and Li₄SiO₄.

### (Technique 6)

The negative electrode active material for secondary batteries according to any one of techniques 1 to 5, wherein
the silicon-containing particles contain an element A2, and
the element A2 is at least one selected from the group consisting of aluminum, boron, bismuth, antimony, germanium, zirconium, titanium, phosphorus, vanadium, tungsten, and lanthanum.

### (Technique 7)

The negative electrode active material for secondary batteries according to technique 6, wherein a content of the element A2 in the silicon-containing particles is 0.01 mass % or more, relative to a total mass of the silicon-containing particles.

### (Technique 8)

The negative electrode active material for secondary batteries according to any one of techniques 1 to 7, wherein a content of the silicon phases in the silicon-containing particles is 30 mass % or more and 90 mass % or less, relative to a total mass of the silicon-containing particles.

### (Technique 9)

The negative electrode active material for secondary batteries according to any one of techniques 1 to 8, wherein a crystallite size of the silicon phases is 20 nm or less.

### (Technique 10)

The negative electrode active material for secondary batteries according to any one of techniques 1 to 9, wherein an average particle diameter of the silicon-containing particles is 4 μm or more and 15 μm or less.

### (Technique 11)

The negative electrode active material for secondary batteries according to any one of techniques 1 to 10, wherein at least one selected from the group consisting of Li₂CO₃, Li₂O, and LiOH is attached to a surface of the silicon-containing particles.

### (Technique 12)

A secondary battery, comprising:
a positive electrode; a negative electrode; and an electrolyte, wherein the negative electrode includes the negative electrode active material for secondary batteries according to any one of techniques 1 to 11.

### (Technique 13)

The secondary battery according to technique 12, wherein the negative electrode includes a negative electrode mixture layer containing the negative electrode active material for secondary batteries, and a negative electrode current collector supporting the negative electrode mixture layer, and
a contained amount of the silicon-containing particles in the negative electrode mixture layer is 1 mass % or more and 50 mass % or less, relative to a total mass of the negative electrode mixture layer.

### EXAMPLES

A detailed description will be given below of Examples of the present disclosure. The present disclosure, however, is not limited to the following Examples.

### Example 1

### (Preparation of Silicon Oxide Phase-Containing Composite Particles)

SiO₂ and Si particles were mixed together, and heated under vacuum conditions, to obtain a vapor, which was then solidified. In this way, SiOₓ particles (silicon oxide phase-containing composite particles) were prepared. At this time, an aluminum metal and a boron compound were added to the mixture of SiO₂ and Si particles serving as sublimation sources, to contain aluminum and boron in the SiOₓ particles (silicon oxide phase).

The crystallite size of the silicon phases was 6 nm. The major component of the silicon oxide phase was SiO₂. The content ratio of the silicon phases in the silicon oxide phase-containing composite particles was 51 mass %.

### (Addition of Li and Element A1 to Silicon Oxide Phase-Containing Composite Particles)

In an inert atmosphere, a mixture of Li₂CO₃, Na₂CO₃, and K₂CO₃ was heated to melt at 500 °C, and the silicon oxide phase-containing composite particles were fed into the molten material. In this way, Li and the element A1 (K and Na) were added abundantly on the surface portion side of the silicon oxide phase-containing composite particles.

The Li, Na, K, Al, and B contents in the composite particles were the values shown in Table 1. The X/Y ratio of the K concentration was set to 6, by adjusting as appropriate the particle diameter of the SiOₓ particles and the feeding time of the SiOₓ particles into the molten material. Here, the concentration X was determined by the aforementioned XPS method, and the concentration Y was determined by the aforementioned ICP atomic emission spectroscopy. In the XPS method, analysis was performed in the depth direction using Ar ion etching, and the concentration X was determined from the atomic ratio data obtained by the XPS method.

### (Formation of Conductive Layer)

Subsequently, 100 parts by mass of the composite particles were mixed with 3 parts by mass of coal tar pitch, and the mixture was fired at 800 °C in an inert atmosphere, to coat the surface of the composite particles with conductive carbon. In this way, a conductive layer was formed on the surface of the composite particles. The coating amount of the conductive layer was set to 3 mass % relative to a total mass of the composite particle and the conductive layer.

### (Production of Negative Electrode)

Graphite and the composite particles having a conductive layer were mixed in a mass ratio of 90:10, and the resultant mixture was used as a negative electrode active material. To 97.5 parts by mass of the negative electrode active material, 1 part by mass of carboxymethyl cellulose (CMC), and 1.5 parts by mass of styrene-butadiene rubber (SBR) were added, to which a predetermined amount of water was further added, to prepare a negative electrode slurry.

The negative electrode slurry was applied onto both surfaces of a copper foil serving as a negative electrode current collector, and the applied films were dried and rolled, followed by cutting into a predetermined size. Thus, a negative electrode with a negative electrode mixture layer formed on both surfaces of the negative electrode current collector was obtained. At this time, a negative electrode current collector-exposed portion was provided at part of the negative electrode.

### (Production of Positive Electrode)

To 95 parts by weight of a positive electrode active material, 2.5 parts by weight of acetylene black, and 2.5 parts by weight of polyvinylidene fluoride were added, to which an appropriate amount of N-methyl-2-pyrrolidone (NMP) was further added, to prepare a positive electrode slurry. The positive electrode active material used here was a lithium-transition metal composite oxide represented by LiNi_{0.88}Co_{0.09}Al_{0.03}O₂.

The positive electrode slurry was applied onto both surfaces of an aluminum foil serving as a positive electrode current collector, and the applied films were dried and rolled, followed by cutting into a predetermined size. Thus, a positive electrode with a positive electrode mixture layer formed on both surfaces of the positive electrode current collector was obtained. At this time, a positive electrode current collector-exposed portion was provided at part of the positive electrode.

### (Preparation of Nonaqueous Electrolyte)

Ethylene carbonate (EC), ethyl methyl carbonate (EMC), and dimethyl carbonate (DMC) were mixed in a volume ratio of 20:5:75, to obtain a mixed solvent. Lithium hexafluorophosphate was dissolved at a concentration of 1 mol/L in the mixed solvent, to prepare a nonaqueous electrolyte.

### (Fabrication of Test Cell)

The negative electrode produced in the above and a lithium metal foil (counter electrode) were prepared. A lead was attached to the negative electrode (negative electrode current collector-exposed portion) and to the lithium metal foil. The negative electrode and the lithium metal foil were spirally wound, with a polyolefin separator interposed therebetween, and then, pressed in the radial direction, into a flat-shaped electrode body. The separator used here was a microporous film made of polyolefin. The electrode body was housed in an outer body made of an aluminum laminate sheet, and after the nonaqueous electrolyte was injected thereinto, the opening of the outer body was sealed. At this time, each of the leads attached to the negative electrode and the counter electrode was partially exposed from the outer body. In this way, a test cell e1 was obtained. The fabrication of the test cell was performed in an argon atmosphere.

The following evaluations 1 and 2 were performed using the fabricated test cell e1.

### (Evaluation 1: Initial Charge-Discharge Efficiency)

In a 25 °C environment, charge was performed at 0.1It until the voltage reached 0.005 V, and then, charge was performed at a voltage of 0.005 V until the current reached 0.01It. After the charge, in a 25 °C environment, discharge was performed at a current of 0.1It until the voltage reached 1 V. A charge capacity C1 and a discharge capacity D1 at this time were determined, to calculate (D1/C1)×100 as a charge-discharge efficiency.

### (Evaluation 2: Rate Characteristics)

In a 25 °C environment, charge was performed at a current of 0.1It until the voltage reached 0.005 V, and then, charge was performed at a voltage of 0.005 V until the current reached 0.01It. After the charge, in a 25 °C environment, discharge was performed at a current of 2It until the voltage reached 1 V. A discharge capacity D2 at this time were determined. Using the obtained discharge capacity D2 during the 2It discharge, and the discharge capacity D1 during the 0.1It discharge determined in the above initial charge-discharge efficiency, (D2/D1)×100 was calculated, to evaluate the rate characteristics.

(Fabrication of secondary battery)

The positive electrode and the negative electrode produced in the above were prepared. A lead was attached to each of the positive electrode current collector-exposed portion and the negative electrode current collector-exposed portion. The positive electrode and the negative electrode were spirally wound, with a polyolefin separator interposed therebetween, and then, pressed in the radial direction, into a flat-shaped electrode body. The separator used here was a microporous film made of polyolefin. The electrode body was housed in an outer body made of an aluminum laminate sheet, and after the nonaqueous electrolyte was injected thereinto, the opening of the outer body was sealed. At this time, each of the leads attached to the positive electrode and the negative electrode was partially exposed from the outer body. In this way, a secondary battery E1 for evaluation was obtained.

The following evaluation 3 was performed using the fabricated secondary battery E1.

(Evaluation 3: Cycle retention rate)

In a 25 °C environment, a cycle test was performed under the following charge-discharge conditions. The rest time between charge and discharge was set to 10 minutes.

### <Charge>

Charge was performed at a current of 1It (800 mA) until the voltage reached 4.2 V, and then, charge was performed at a voltage of 4.2 V until the current reached 1/20It (40 mA).

### <Discharge>

Discharge was performed at a current of 1It (800 mA) until the voltage reached 2.75 V.

Under the above conditions, charge and discharge were repeated up to 200 cycles, and the ratio of a discharge capacity at the 200th cycle to a discharge capacity at the 1st cycle was determined as a cycle retention rate (%).

### Example 2

A test cell e2 and a secondary battery E2 were fabricated and evaluated in the same manner as in Example 1, except that the silicon oxide phase-containing composite particles with Li and an element A1 (K and Na) added thereto were further subjected to a heat treatment at 800 °C for 5 hours in an inert atmosphere.

The crystallite size of the silicon phases was 6 nm. The X/Y ratio of the K concentration was set to 18, by adjusting as appropriate the feeding time of the silicon oxide phase-containing composite particles into the molten material.

### Example 3

The same silicon oxide phase-containing composite particles as those of Example 1 were prepared.

In an inert atmosphere, a mixture of Li₂CO₃ and MgCO₃ was heated to melt at 500 °C, and the silicon oxide phase-containing composite particles were fed into the molten material. In this way, the Li and the element A1 (Mg) were added abundantly on the surface portion side of the silicon oxide phase-containing composite particles.

The Li, Mg, Al, and B contents in the composite particles were the values shown in Table 1. The X/Y ratio of the Mg concentration was set to 20, by adjusting as appropriate the particle diameter of the SiOₓ particles, and the feeding time of the SiOₓ particles into the molten material.

Furthermore, the silicon oxide phase-containing composite particles with Li and an element A1 (Mg) added thereto were further subjected to a heat treatment at a predetermined temperature for a predetermined time in an inert atmosphere. The crystallite size of the silicon phases was 13 nm.

A test cell e3 and a secondary battery E3 were fabricated and evaluated in the same manner as in Example 1, except that the composite particles prepared in the above were used.

### Examples 4 and 5

### (Preparation of Lithium Silicate-Containing Composite Particles)

Lithium carbonate (Li₂CO₃) serving as a Li raw material, silicon dioxide (SiO₂) serving as a Si raw material, and a raw material containing an element A2 were mixed together, to obtain a mixture. The mixture was obtained such that the atomic ratio Si/Li of Si to Li was 1.05. As the raw material containing an element A2, aluminum oxide (Al₂O₃) and boron oxide (B₂O₃) were used. The mixture was fired at 800 °C for 10 hours in an inert gas atmosphere, to obtain a lithium silicate containing Al and B. The resultant lithium silicate was pulverized to have an average particle diameter of 10 μm.

The pulverized lithium silicate containing Al and B was mixed with a raw material silicon (3N, average particle diameter 10 μm) in a mass ratio of 40:60. The mixture was packed in a pot (made of SUS, volume: 500 mL) of a planetary ball mill (P-5, available from Fritsch Co., Ltd.). Next, 24 SUS balls (diameter 20 mm) were put into the pot, and with the lid closed, the mixture was pulverized at 200 rpm for 50 hours in an inert atmosphere.

Next, the powdered mixture was taken out in an inert atmosphere, which was then fired at 600 °C for 4 hours in an inert atmosphere under application of a pressure thereto with a hot press, to obtain a sintered body of the mixture. The resultant sintered body was pulverized, and passed through a 40 μm mesh, to obtain composite particles (lithium silicate phase-containing composite particles). Then, using a sieve, composite particles having an average particle diameter of 10 μm were obtained.

The crystallite size of the silicon phases was 50 nm. The major component of the silicate phase was Li₂Si₂O₅, and the content ratio of the silicon phases in the lithium silicate phase-containing composite particles was approximately 60 mass %.

### (Addition of Element A1 to Lithium Silicate Phase-Containing Composite Particles)

In an inert atmosphere, a mixture of Na₂CO₃ and K₂CO₃ was heated to melt at 500 °C, and lithium silicate phase-containing composite particles were fed into the molten material. In this way, the element A1 was added abundantly on the surface portion side of the lithium silicate phase-containing composite particles.

The Li, Na, K, Al, and B contents in the composite particles were the values shown in Table 1. The X/Y ratio of the K concentration was set to 3, by adjusting as appropriate the particle diameter of the composite particles, and the feeding time of the composite particles into the molten material.

Test cells e4 and e5, and secondary batteries E4 and E5 were fabricated and evaluated in the same manner as in Example 1, except that the composite particles prepared in the above were used.

### Comparative Example 1

Neither Al nor B was contained in the silicon oxide phase in the composite particles. Neither lithium nor the element A1 was added to the composite particles. Except for the above, in the same manner as in Example 1, a test cell r1 and a secondary battery R1 were fabricated and evaluated.

### Comparative Example 2

A test cell r2 and a secondary battery R2 were fabricated and evaluated in the same manner as in Example 1, except that neither lithium nor the element A1 was added to the composite particles.

### Comparative Example 3

A test cell r3 and a secondary battery R3 were fabricated and evaluated in the same manner as in Example 1, except that the element A1 was not added to the composite particles.

### Comparative Examples 4 and 5

Lithium carbonate (Li₂CO₃) serving as a Li raw material, silicon dioxide (SiO₂) serving as a Si raw material, a raw material containing an element A1, and a raw material containing an element A2 were mixed together, to obtain a mixture. The mixture was obtained such that the atomic ratio Si/Li of Si to Li was 1.05. As the raw material containing an element A1, sodium carbonate (Na₂CO₃) and potassium carbonate (K₂CO₃) were used. As the raw material containing an element A2, aluminum oxide (Al₂O₃) and boron oxide (B₂O₃) were used. The mixture was fired at 800 °C for 10 hours in an inert gas atmosphere, to obtain a lithium silicate containing Na, K, Al, and B.

Lithium silicate phase-containing composite particles were prepared in the same manner as in Example 3, except that the lithium silicate containing Na, K, Al, and B was used instead of the lithium silicate containing Al and B. The Li, Na, K, Al, and B contents in the composite particles were the values shown in Table 1.

In this way, the element A1 (Na and K) was distributed almost uniformly in the depth direction of the composite particle. The X/Y ratio of the K concentration in the resultant composite particles was 1. The X/Y ratio of the Na concentration was also 1.

Test cells r4 and r5 and secondary batteries R4 and R5 were prepared and evaluated in the same manner as in Example 1, except that the composite particles prepared in the above were used.

The evaluation results are shown in Table 1. In Table 1, the X/Y ratio of the K concentration or the Mg concentration is also shown. In Examples E1 (e1), E2 (e2), E4 (e4), E5 (e5), R4 (r4) and R5 (r5), although K and Na were contained as the element A1 in the composite particles, the values of the X/Y ratio of the Na concentration were similar to those of the K concentration. The Li, Na, K, Al, and B contents in the composite particles in Table 1 are each expressed as a mass ratio relative to the total mass of the produced composite particles.

TABLE 1

| | silicon-containing particles (composite particles) | | | | | | | | | performance evaluation | | |
|---|---|---|---|---|---|---|---|---|---|---|---|---|
| | | | | | | | | crystallite | X/Y ratio of | initial | | |
| secondary | | | | | | | | size of | K | charge- | | cycle |
| battery | | | | | | | | silicon | concentration | discharge | rate | retention |
| (test | silicon compound | element content (mass %) | | | | | | phases | or Mg | efficiency | characteristics | rate |
| cell) | phase | Li | Na | K | Mg | Al | B | (nm) | concentration | (%) | (%) | (%) |
| R1 (r1) | silicon oxide phase | 0 | 0 | 0 | 0 | 0 | 0 | 5 | — | 67 | 35 | 90 |
| R2 (r2) | silicon oxide phase | 0 | 0 | 0 | 0 | 2 | 1 | 5 | — | 70 | 38 | 90 |
| R3 (r3) | silicon oxide phase | 5 | 0 | 0 | 0 | 2 | 1 | 5 | — | 80 | 39 | 90 |
| E1 (e1) | silicon oxide phase | 5 | 1 | 1 | 0 | 2 | 1 | 6 | 6 | 82 | 52 | 91 |
| E2 (e2) | silicon oxide phase | 5 | 1 | 1 | 0 | 2 | 1 | 11 | 18 | 83 | 51 | 88 |
| E3 (e3) | silicon oxide phase | 5 | 0 | 0 | 1 | 2 | 1 | 13 | 20 | 83 | 48 | 85 |
| R4 (r4) | lithium silicate phase | 5 | 1 | 1 | 0 | 2 | 1 | 50 | 1 | 80 | 39 | 85 |
| E4 (e4) | lithium silicate phase | 5 | 1 | 1 | 0 | 2 | 1 | 50 | 3 | 82 | 48 | 85 |
| R5 (r5) | lithium silicate phase | 5 | 2 | 2 | 0 | 2 | 1 | 50 | 1 | 83 | 40 | 79 |
| E5 (e5) | lithium silicate phase | 5 | 2 | 2 | 0 | 2 | 1 | 50 | 3 | 83 | 52 | 83 |

In the Examples, the reactivity of the composite particles was high, and the rate performance was improved (e1 to e5). In the Examples, cracking of the composite particles was suppressed, and the deterioration in cycle performance due to particle cracking was suppressed (E1 to E5). In the Comparative Examples, the reactivity of the composite particles was low, resulting in lowered rate characteristics (r1 to r5).

### INDUSTRIAL APPLICABILITY

The secondary battery according to the present disclosure is useful as a main power source for mobile communication devices, portable electronic devices, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: electrode group, 2: positive electrode lead, 3: negative electrode lead, 4: battery case, 5: sealing plate, 6: negative electrode terminal, 7: gasket, 8: sealing plug. 20: negative electrode active material, 21: ion-conducting phase, 22: silicon phase, 23: composite particle, 26: conductive layer

1. A negative electrode active material for secondary batteries, comprising:
silicon-containing particles, the silicon-containing particles each including an ion-conducting phase, and silicon phases dispersed in the ion-conducting phase, wherein
the silicon-containing particles contain lithium and an element A1,
a concentration of the element A1 is higher in a surface portion than in an interior of the silicon-containing particle, and
the element A1 is at least one selected from the group consisting of an alkali metal element other than lithium and a Group II element in a long-form periodic table.

2. The negative electrode active material for secondary batteries according to claim 1, wherein the element A1 is at least one selected from the group consisting of sodium, potassium, magnesium, and calcium.

3. The negative electrode active material for secondary batteries according to claim 1, wherein,
given that a concentration of the element A1 at a depth of 100 nm from a surface of the silicon-containing particle is X mass %, and
a concentration of the element A1 in the whole silicon-containing particle is Y mass %,
a ratio of X/Y is 2 or more.

4. The negative electrode active material for secondary batteries according to claim 1, wherein the ion-conducting phase includes at least one selected from the group consisting of a silicate phase and a silicon oxide phase.

5. The negative electrode active material for secondary batteries according to claim 4, wherein the silicate phase includes at least one selected from the group consisting of Li₂Si₂O₅, Li₂SiO₃, and Li₄SiO₄.

6. The negative electrode active material for secondary batteries according to claim 1, wherein
the silicon-containing particles contain an element A2, and
the element A2 is at least one selected from the group consisting of aluminum, boron, bismuth, antimony, germanium, zirconium, titanium, phosphorus, vanadium, tungsten, and lanthanum.

7. The negative electrode active material for secondary batteries according to claim 6, wherein a content of the element A2 in the silicon-containing particles is 0.01 mass % or more, relative to a total mass of the silicon-containing particles.

8. The negative electrode active material for secondary batteries according to claim 1, wherein a content of the silicon phases in the silicon-containing particles is 30 mass % or more and 90 mass % or less, relative to a total mass of the silicon-containing particles.

9. The negative electrode active material for secondary batteries according to claim 1, wherein a crystallite size of the silicon phases is 20 nm or less.

10. The negative electrode active material for secondary batteries according to claim 1, wherein an average particle diameter of the silicon-containing particles is 4 μm or more and 15 μm or less.

11. The negative electrode active material for secondary batteries according to claim 1, wherein at least one selected from the group consisting of Li₂CO₃, Li₂O, and LiOH is attached to a surface of the silicon-containing particles.

12. A secondary battery, comprising:
a positive electrode; a negative electrode; and an electrolyte, wherein
the negative electrode includes the negative electrode active material for secondary batteries according to claim 1.

13. The secondary battery according to claim 12, wherein
the negative electrode includes a negative electrode mixture layer containing the negative electrode active material for secondary batteries, and a negative electrode current collector supporting the negative electrode mixture layer, and
a contained amount of the silicon-containing particles in the negative electrode mixture layer is 1 mass % or more and 50 mass % or less, relative to a total mass of the negative electrode mixture layer.
